(19) United States
(12) Patent Application Publication
(10) Pub. No.: US 2023/0102145 A1
(43) Pub. Date: Mar. 30, 2023

(54) XY Model Computing Device and Combination Optimization Problem Computing Device

(71) Applicant: Nippon Telegraph and Telephone Corporation, Tokyo (JP)

(72) Inventors: Kensuke Inaba, Musashino-shi, Tokyo (JP); Hiroki Takesue, Musashino-shi, Tokyo (JP); Toshimori Honjo, Musashino-shi, Tokyo (JP); Takahiro Inagaki, Musashino-shi, Tokyo (JP); Yasuhiro Yamada, Musashino-shi, Tokyo (JP); Takuya Ikuta, Musashino-shi, Tokyo (JP)

(21) Appl. No.: 17/802,879

(22) PCT Filed: Mar. 3, 2020
(86) PCT No.: PCT/JP2020/009006

§ 371 Date: Aug. 26, 2022

(51) Int. Cl. G06F 30/20; G06N 3/049; G06F 17/18

(52) U.S. Cl. CPC G06F 30/20; G06N 3/049; G06F 17/18

(57) ABSTRACT

An XY model calculation apparatus of the present disclosure includes a resonator unit that amplifies a plurality of optical pulses, a measurement unit that measures phases and amplitudes of the plurality of optical pulses to obtain a measurement result, and a feedback configuration that calculates and feeds back an interaction related to a certain optical pulse of the plurality of optical pulses by using a coupling coefficient of an Ising model in response to the measurement result. The feedback configuration is configured to perform a feedback input of a correlation to be determined by a coupling coefficient of two optical pulses of the plurality of optical pulses and is configured so that only one component of pulsed light is to be measured.

### TECHNICAL FIELD

The present technology relates to an XY model calculation apparatus that simulates an XY model by using an optical pulse, and more specifically, relates to an XY model calculation apparatus using an optical parametric oscillator (OPO).

### BACKGROUND ART

A known von Neumann computer cannot efficiently solve combination optimization problems classified as an NP problem. A proposed method for solving combination optimization problems includes a method using an Ising model, which is a lattice model in which a magnetic material is statistically analyzed as an interaction of spins at respective sites of lattice points. A coherent Ising machine (CIM) that simulates and efficiently calculates the Ising model by using an optical parametric oscillation pulse has been proposed (PTL 1 and NPL 1).

In addition, calculating an XY model by using one non-degenerate OPO pulse has been proposed (NPL 2).

Similar to the Ising model, the XY model is proposed as a model for a magnetic body and expresses a state in which two-dimensional vectors are arranged at respective lattice points, similar to the Ising model.

Similar to the Ising model and the like, the XY model here is one example of a simplified spin model, similar to the Ising model. The XY model represents spins at the lattice points with a two-dimensional classical vector and are expressed as follows.

H_{xy}=ΣᵢⱼKᵢⱼsᵢ·sⱼ=ΣᵢⱼKᵢⱼ cos(θᵢ−θⱼ)

sᵢ=(sₓᵢ,s_{yi}) where |sᵢ|=1. Math. 1

θᵢ Math. 2

indicates a phase of an i-th spin, where i is a natural number.

θⱼ Math. 3

indicates a phase of a j-th spin, where j is a natural number.

The XY model is well known as a model for describing the Kosterlitz-Thouless transition, for example, in a superfluid thin film of helium-4. If the solution to this model can be obtained efficiently, the XY model can be applied to the structural analysis of high molecular substances, such as proteins, spectroscopy, and optimization problems of community detection and the like.

A model in which a neural network is constructed of spiking neurons is called a spiking neural network. Such a spiking puts a neural network closer to a biological function of the brain and is an artificial neural network model created with an emphasis on action potentials (spikes). In spiking neural networks, a timing at which a spike occurs is considered as information, and the number of parameters to be handled increases. Consequently, the spiking neural networks are referred to as a next-generation technology that can handle a wider range of problems than deep learning. When neural network processing is implemented on a von Neumann computer for sequential processing, the processing efficiency generally decreases. Furthermore, in the case of a spiking neural network, it is necessary to also imitate the action potential, further deceasing the processing efficiency. Consequently, in simulating a neural network, a dedicated processor is often implemented (NPL 3).

### CITATION LIST

### Patent Literature

PTL 1: WO 2015/156126 Pamphlet

### Non Patent Literature

NPL 1: T. Inagaki, Y. Haribara, et al, “A coherent ising machine for 2000-node optimization problems”, Science, (2016), 354, 603-606.
NPL 2: Y. Takeda, S. Tamate, Y. Yamamoto, H. Takesue, T. Inagaki and S. Utsunomiya, “Boltzmann sampling for an XY model using a non-degenerate optical parametric oscillator network”, Quantum Science and Technology, (2018), Volume 3, 014004.
NPL 3: P. A. Merolla et al., “A million spiking-neuron integrated circuit with a scalable communication network and interface”, Science, (2014), 345 (6197): 668, doi:10.1126/science.1254642. PMID 25104385.

A coherent Ising machine of the related technology is specialized for solving Ising problems, that is, integer combination optimization problems but is not suited for the application to combination optimizations expressed by real numbers.

In addition, the related technology requires the measurement of two components (in-phase and quadrature components) of pulsed light, complicating the device configuration. Furthermore, when a spiking neuron model or an Ising model is calculated in the same device, it is necessary to drastically change the device configuration, and thus, unfortunately, reducing the range of computable models (NPL 2).

### SUMMARY OF THE INVENTION

The present technology has been developed in view of the issues of the related art, and an object of the present technology is to provide an XY model calculation apparatus that measures only one component (an in-phase component) of the two components (in-phase and quadrature components) of the pulsed light.

To solve the above-described issues, one aspect of an XY model calculation apparatus is to include a resonator unit that amplifies a plurality of optical pulses, a measurement unit that measures phases and amplitudes of the plurality of optical pulses to obtain a measurement result, and a feedback configuration that calculates and feeds back an interaction related to a certain optical pulse of the plurality of optical pulses by using a coupling coefficient of an Ising mode in response to the measurement result and a coupling coefficient of an Ising model, and the XY model calculation apparatus is characterized in that the feedback configuration is configured to perform a feedback input of a correlation to be determined by a coupling coefficient of two optical pulses of the plurality of optical pulses, and is configured so that only one component (an in-phase component) of the pulsed light is to be measured.

### Effects of the Invention

The XY model calculation apparatus according to the disclosure of the present technology measures only one component (an in-phase component) of pulsed light. This simplifies the device configuration, and thus, an advantageous effect of capable of also calculating a spiking neuron model or an Ising model with substantially the same device configuration is obtained.

### BRIEF DESCRIPTION OF DRAWINGS

FIG. 1 is a diagram illustrating a basic configuration of a coherent Ising machine.

FIG. 2 is a diagram for describing an implementation of a spiking neuron.

FIG. 3A illustrates trajectories of amplitudes of two pulses in a vw-plane when amplitude correction is not performed. FIG. 3B illustrates trajectories of amplitudes of two pulses in a vw-plane when amplitude correction is performed.

FIG. 4A is a diagram illustrating a relationship between the number of steps (time) and energy when amplitude correction is not performed in a complex XY model. FIG. 4B is a diagram illustrating a relationship between the number of steps (time) and the energy when amplitude correction is performed in the complex XY model.

### DESCRIPTION OF EMBODIMENTS

Below, embodiments of the present invention will be described in detail.

In an XY model calculation apparatus of the present embodiment, a state of one spiking neuron is implemented for two OPO pulses of a coherent Ising machine. The XY model calculation apparatus includes a resonator unit that amplifies a plurality of optical pulses (OPO pulses), a measurement unit that measures phases and amplitudes of the plurality of optical pulses to obtain a measurement result, and a feedback configuration that uses the measurement result and a coupling coefficient of the Ising model to calculate and feed back an interaction related to certain optical pulses. Here, a coherent Ising machine that realizes a spiking neuron apparatus of the present embodiment will be described.

### First Embodiment

A coupling matrix Jij describing a feedback signal in a degenerate optical parametric oscillator (DOPO) spiking neuron apparatus is set so as to be given by (Equation 10) described later.

A calculation apparatus capable of solving an XY model (hereinafter, referred to as a Hamiltonian) is created by extending the DOPO spiking neuron apparatus (DOPO-SNN). DOPO-spiking neural networks (SNNs), coherent Ising machines (CIMs), and Potts model calculation apparatuses of the related art are adapted for solving combination optimization problems of integers, and the calculation apparatus capable of solving XY models can be applied to combination optimization problems expressed by real numbers.

The XY model calculation apparatus is used to realize an apparatus that calculates a low energy state of the XY model in which a variable is described by a real number θ using a coupling matrix. The real number θ is given by an argument θ in a plane having, as axes, amplitudes of two optical pulses (DOPO pulses) that form a spiking neuron. If the firing state of the spiking neuron is controlled by the present technique, the argument θ changes continuously so as to rotate from 0 to 2π. Consequently, it is possible to obtain the argument as a variable θ of a real number.

### Coherent Ising Machine

It is not possible to efficiently solve combination optimization problems classified as NP problems with von Neumann computers known in the related art. As a procedure for solving combination optimization problems, a procedure has been proposed that uses the Ising model, which is a lattice model for statistically analyzing a magnetic material by using interactions of spins at each site of lattice points.

It is known that a Hamiltonian Hxy, which is an energy function of the Ising model system, is expressed by Equation (1) below.

$$\begin{matrix}Math . 4 & \\ {H}_{xy} = {\sum }_{ij} {K}_{ij} cos ( {θ}_{i} - {θ}_{j} ) & ( 1 )\end{matrix}$$

Furthermore, a complex (numerical system) Hamiltonian Hcxy is expressed as follows.

Math. 5

H_{cxy}=ΣᵢⱼKᵢⱼ exp[i(θᵢ−θⱼ)] (2)

In Equations (1) and (2), Kᵢⱼ is a coupling matrix and indicates a correlation of sites constituting the Ising model.

By inputting a feedback signal generated by an arithmetic device of the XY model calculation apparatus, it is possible to calculate the low energy state of the XY model.

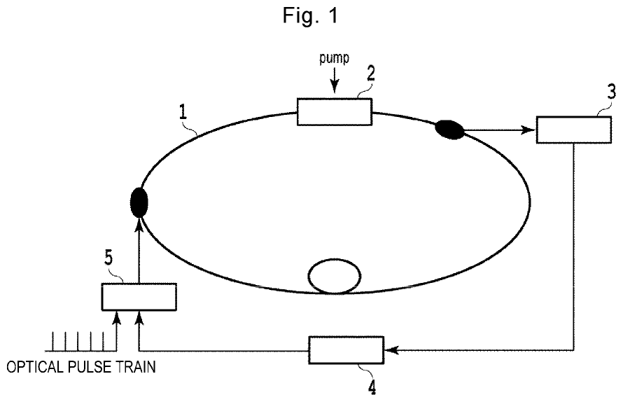

FIG. 1 is a diagram illustrating a basic configuration of a coherent Ising machine. As illustrated in FIG. 1, the coherent Ising machine is configured to inject a pump light pulse (pump) to a phase sensitive amplifier (PSA) 2 provided in a ring-shaped optical fiber functioning as a ring resonator 1, so that an optical pulse train including a number of optical pulses corresponding to the number of sites in the Ising model is generated (a binary optical parametric oscillator (OPO): 0 or π-phase optical parametric oscillator). The ring resonator 1 and the phase sensitive amplifier 2 form a resonator unit.

As illustrated in FIG. 1, the coherent Ising machine further includes a measurement unit 3 that measures the optical pulse train, an arithmetic device 4 that provides feedback to the optical pulse, based on a measurement result, and an external optical pulse input unit 5.

When the optical pulse train input to the ring resonator 1 completes one round and reaches the PSA 2 again, pump light is again input to the PSA 2 to amplify the optical pulse train. The optical pulse train generated by the first injection of the pump light is a weak optical pulse having a phase that is not fixed, but the optical pulse train is amplified by the PSA 2 in every round in the ring resonator 1, so that the phase state of the optical pulse train is gradually fixed. The PSA 2 amplifies each optical pulse in a phase of 0 or π with respect to the phase of the pump light source, and thus, the phase of the optical pulse is fixed to any one of the phase states 0 and π.

In the coherent Ising machine, spins 1 and −1 in the Ising model are implemented corresponding to the phases 0 and π of the optical pulse. The phase and amplitude of the optical pulse train are measured by the measurement unit 3 outside the ring resonator 1 for each round the optical pulse moves in the ring resonator 1. The measurement result is input to the arithmetic device 4 with a coupling coefficient Kij given in advance, and the measurement result and the coupling coefficient Kij are used to calculate a coupling signal for the i-th optical pulse (a signal to be input as feedback)

Math. 6

\tilde{α}ᵢ=ΣᵢⱼKᵢⱼvⱼ (3)

Math. 7

\tilde{β}ᵢ=ΣᵢⱼKᵢⱼwⱼ (4)

(vⱼ: amplitude of an optical pulse v at the j-th site, wⱼ: amplitude of an optical pulse w at the j-th site). Then, an external optical pulse according to the calculated coupling signal is generated by the external optical pulse input unit 5 and input to the ring resonator 1. This feedback loop control can impart a correlation of phases between the optical pulses constituting the optical pulse train.

In a coherent Ising machine, the optical pulse train can be amplified in every round the optical pulse train moves in the ring resonator 1, while being imparted with the above-mentioned correlation, and when a stable state is reached, the phases 0 and π of the optical pulses constituting the optical pulse train can be measured to solve the Ising model.

The configuration of the coherent Ising machine illustrated in FIG. 1 is an example of a coherent Ising machine, and in FIG. 1, the feedback configuration includes the arithmetic device 4 and the external optical pulse input unit 5, for example. Alternatively, instead of using the external optical pulse input unit 5, a modulator may be provided in the ring resonator 1 to modulate the optical pulse into an optical pulse propagating circumferentially in the ring resonator 1. The coherent Ising machine that can be used in the XY model calculation apparatus of the present embodiment is not limited to the configuration illustrated in FIG. 1, and alternatively, a known configuration including a resonator unit, a measurement unit, and a feedback configuration may be used.

### Simulation of Spiking Neuron

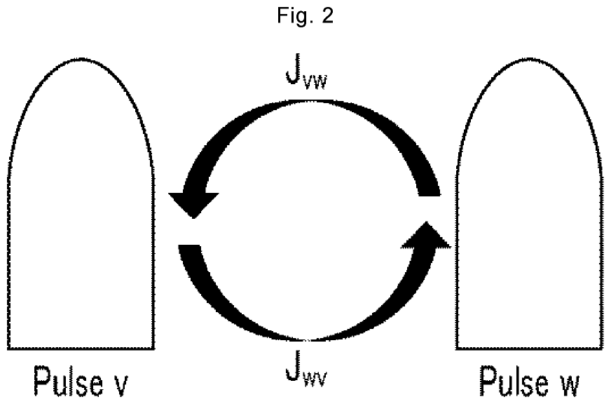

FIG. 2 is a diagram for describing an implementation of a spiking neuron. In the spiking neuron apparatus of the present embodiment, the correlation determined by the two coupling coefficients is input as feedback to the two OPO pulses (optical pulses) constituting the coherent Ising machine. In the present embodiment, a first half of an optical pulse train Cj, where j is an integer from 1 to 2N and N is a natural number, consisting of 2N optical pulses is defined as vᵢ (i being an integer from 1 to N), and a second half of the optical pulse train Cj is defined as wᵢ. As illustrated in FIG. 2, in the optical pulse (Pulse) v and the optical pulse w calculated by using J_{vw} and J_{wv}(=−J_{vw}) as coupling coefficients of the optical pulse v and the optical pulse w belonging to the same i, a state of one spiking neuron is simulated by values of the two optical pulses v and w. That is, N neurons are simulated by 2N optical pulses.

When the configuration includes the coherent Ising machine illustrated in FIG. 1, the measurement result of the optical pulse Cj obtained from coherent measurement by the measurement device 3 is used by the arithmetic device 4 to perform computation by Equation (5) below.

Math. 8

αᵢ=ΣⱼJᵢⱼCⱼ+Fᵢ (5)

In Equation (5) above, Fᵢ is a magnetic field term. Jᵢⱼ is a correlation (a coupling matrix) determined by the coupling coefficients, and is specifically given as follows.

$$\begin{matrix}Math . 9 & \\ ( \begin{matrix}0 & {K}_{21} & {K}_{31} & & {J}_{wv} & 0 & 0 \\ {K}_{12} & 0 & {K}_{32} & … & 0 & {J}_{wv} & 0 \\ {K}_{13} & {K}_{23} & 0 & & 0 & 0 & {J}_{wv} \\ & ⋮ & & ⋱ & & ⋮ & \\ {J}_{vw} & 0 & 0 & & 0 & {K}_{21} & {K}_{31} \\ 0 & {J}_{vw} & 0 & … & {K}_{12} & 0 & {K}_{32} \\ 0 & 0 & {J}_{vw} & & {K}_{13} & {K}_{23} & 0\end{matrix} ) & ( 6 )\end{matrix}$$

The pair of the optical pulses vᵢ and wᵢ indicates a state of the i-th spiking neuron by the matrix mentioned above. At this time, equations satisfied by the i-th pair of v and w are given by Equations (7) and (8) below (the subscript i being omitted in Equations (7) and (8)). The behavior of the spiking neuron in the present apparatus is characterized by these equations. When the operation of the DOPO spiking neuron apparatus can be expressed by Equations (7) and (8) below, the DOPO spiking neuron apparatus functions as an XY model calculation apparatus.

$$\begin{matrix}Math . 10 & \\ \frac{{dv}_{i}}{dt} = ( - 1 + {p}_{i} - {v}_{i}^{2} ) {v}_{i} + {J}_{vw} {w}_{i} - ξ ( {\sum }_{ij} {K}_{ij} {v}_{j} ) where {J}_{vw} = - {J}_{wv} . & ( 7 )\end{matrix}$$

$$\begin{matrix}Math . 11 & \\ \frac{d {w}_{i}}{d t} = ( - 1 + {p}_{i} - {w}_{i}^{2} ) {w}_{i} + {J}_{wv} {v}_{i} - ξ ( {\sum }_{ij} {K}_{ij} {w}_{j} ) & ( 8 )\end{matrix}$$

In Equations (7) and (8), p represents the intensity of the pump light and is normalized so that the oscillation threshold value is p=1. For convenience, P=p−1 may be set.

Note that in the case of a complex XY model, a coupling signal (a signal to be input as feedback) for the i-th optical pulse is calculated by Equations (9) and (10)

Math. 12

\tilde{α}ᵢ=(Σᵢⱼ( [symbol] Kᵢⱼvⱼ+ℑKᵢⱼwⱼ))αᵢ=J_{vw}wᵢ+\tilde{α}ᵢ (9)

Math. 13

\tilde{β}ᵢ=(Σᵢⱼ( [symbol] Kᵢⱼwⱼ−ℑKᵢⱼvⱼ))βᵢ=J_{wv}vᵢ+\tilde{β}ᵢ (10)

where vⱼ is the amplitude of the optical pulse v at the j-th site and wⱼ is the amplitude of the optical pulse w at the j-th site. Furthermore, the coupling matrix is defined as expressed in Equation (11).

$$\begin{matrix}Math . 14 & \\ {J}_{ij} = ( \begin{matrix}0 & {K}_{21} & {K}_{31} & & {J}_{wv} & - {K}_{21} & - {K}_{31} \\ {K}_{12} & 0 & {K}_{32} & … & - {K}_{12} & {J}_{wv} & - {K}_{32} \\ {K}_{13} & {K}_{23} & 0 & & - {K}_{13} & - {K}_{23} & {J}_{wv} \\ & ⋮ & & ⋱ & & ⋮ & \\ {J}_{wv} & {K}_{21} & {K}_{31} & & 0 & {K}_{21} & {K}_{31} \\ {K}_{12} & {J}_{wv} & {K}_{32} & … & {K}_{12} & 0 & {K}_{32} \\ {K}_{13} & {K}_{23} & {J}_{wv} & & {K}_{13} & {K}_{23} & 0\end{matrix} ) \\ {K}_{ij} : Real part of Kij \\ {K}_{ij} : Imaginary part of Kij & ( 11 )\end{matrix}$$

The variable of the XY model

θᵢ Math. 15

is defined as

arg(vᵢ+iwᵢ) Math. 16

This corresponds to an argument in a plane formed by

(vᵢ,wᵢ) Math. 17

which is the amplitudes of the two pulses constituting the DOPO spiking neuron. In a firing state of the spiking neuron,

θᵢ Math. 18

changes continuously so as to rotate from 0 to 2π.

The XY model calculation apparatus of the present embodiment includes a resonator unit that amplifies a plurality of optical pulses, a measurement unit that measures phases and amplitudes of the plurality of optical pulses to obtain a measurement result, and a feedback configuration that uses the measurement result and a coupling coefficient of the Ising model to calculate and feed back an interaction related to certain optical pulses. Furthermore, in the XY model calculation apparatus of the present embodiment, the feedback configuration is configured to input as feedback a correlation determined by the coupling coefficient of two optical pulses of the plurality of optical pulses, and only one component (an in-phase component) of pulsed light is measured. It is possible to use an apparatus having the same configuration as the coherent Ising machine apparatus of the related art. Here, the variable is described by the real number θ, and when Equation (1) expressing the energy of the XY model

$$\begin{matrix}Math . 19 & \\ {H}_{x y} = {\sum }_{ij} {K}_{ij} cos ( {θ}_{i} - {θ}_{j} ) & ( 1 )\end{matrix}$$

satisfies the coupling matrix

Jᵢⱼ Math. 20

of Equation (6)

$$\begin{matrix}Math . 21 & \\ {J}_{ij} = ( \begin{matrix}0 & {K}_{21} & {K}_{31} & & {J}_{wv} & 0 & 0 \\ {K}_{12} & 0 & {K}_{32} & … & 0 & {J}_{wv} & 0 \\ {K}_{13} & {K}_{23} & 0 & & 0 & 0 & {J}_{wv} \\ & ⋮ & & ⋱ & & ⋮ & \\ {J}_{vw} & 0 & 0 & & 0 & {K}_{21} & {K}_{31} \\ 0 & {J}_{vw} & 0 & … & {K}_{12} & 0 & {K}_{32} \\ 0 & 0 & {J}_{vw} & & {K}_{13} & {K}_{23} & 0\end{matrix} ) & ( 6 )\end{matrix}$$

and Equation (2) expressing the energy of the complex XY model

Math. 22

H_{cxy}=ΣᵢⱼKᵢⱼ exp[i(θᵢ−θⱼ)] (2)

satisfies the coupling matrix of Equation (11),

$$\begin{matrix}Math . 23 & \\ {J}_{ij} = ( \begin{matrix}0 & {K}_{21} & {K}_{31} & & {J}_{wv} & - {K}_{21} & - {K}_{31} \\ {K}_{12} & 0 & {K}_{32} & … & - {K}_{12} & {J}_{wv} & - {K}_{32} \\ {K}_{13} & {K}_{23} & 0 & & - {K}_{13} & - {K}_{23} & {J}_{wv} \\ & ⋮ & & ⋱ & & ⋮ & \\ {J}_{wv} & {K}_{21} & {K}_{31} & & 0 & {K}_{21} & {K}_{31} \\ {K}_{12} & {J}_{wv} & {K}_{32} & … & {K}_{12} & 0 & {K}_{32} \\ {K}_{13} & {K}_{23} & {J}_{wv} & & {K}_{13} & {K}_{23} & 0\end{matrix} ) \\ {K}_{ij} : Real part of Kij \\ {K}_{ij} : Imaginary part of Kij & ( 11 )\end{matrix}$$

an apparatus for calculating a low energy state is obtained. The real number θ is given by an argument in a plane having, as axes, the two amplitudes (of the DOPO pulses) constituting the spiking neuron. If the firing state of the spiking neuron is controlled by the method described in the present embodiment, the argument θ changes continuously so as to rotate from 0 to 2π. Thus, it is possible to obtain a variable θ expressed by a real number, and to use the variable θ to search for a low energy state of the XY model.

### Second Embodiment

A method of significantly improving the calculation accuracy by inputting a feedback signal (Equation 13) in order to smoothly control the firing state of the apparatus will be described. An apparatus similar to that of the first embodiment can be used, except for the feedback signal.

Control Feedback of Amplitude

In some cases, the amplitude of light changes depending on i, and thus, the accuracy may be insufficient. In such cases, the apparatus may not function as an XY model solver, except for a specific case. Thus,

αᵢ,\tilde{α}ᵢ,βᵢ, [symbol] ,J_{wv},vᵢ,wᵢ Math. 24

of Equations (9) and (10) of the first embodiment are used to expand the feedback signal as described below.

$$\begin{matrix}Math . 25 & \\ {α}_{i} = {J}_{vw} {w}_{i} + {\tilde{α}}_{i} - {E}_{i} {v}_{i} \\ {β}_{i} = {J}_{wv} {v}_{i} + {\tilde{β}}_{i} - {E}_{i} {w}_{i} \\ {E}_{i} = ( \frac{{\tilde{α}}_{i} {v}_{i} + {\tilde{β}}_{i} {w}_{i}}{{v}_{i}^{2} + {w}_{i}^{2}} ) & ( 12 )\end{matrix}$$

When

Eᵢ=0, Math. 26

the feedback signal is the feedback signal before expansion.

Equations (12) are obtained from a feedback signal of an apparatus of the related art

$${α}_{i} = {\sum }_{j} {J}_{i j} {C}_{j} + {F}_{i} \qquad Math . 27$$

in which

Fᵢ=−EᵢCᵢ. Math. 28

When

Math. 29

αᵢ=ΣⱼJᵢⱼCⱼ−EᵢCᵢ (13)

is used as a feedback signal to expand the feedback signal, it is possible to adjust the size of the amplitude. A result of a numerical simulation confirming that the size of the amplitude can be adjusted is described below.

In the numerical simulation, a complex XY model in which the number of spins N is 100 and a coupling constant Kij which is a matrix of complex numbers are randomly generated.

Furthermore, a quasi-Newton method is used to find a solution. However, when the size of N is small, for example, several tens of numerical values, it is only possible to obtain a solution similar to that of quasi-Newton.

When N is about 300, the score of the SNN tends to be better. Note that the number of steps is constant.

The score also depends on the density of the coupling constant Kij. When the coupling constant Kij has high density, the SNN tends to be stronger.

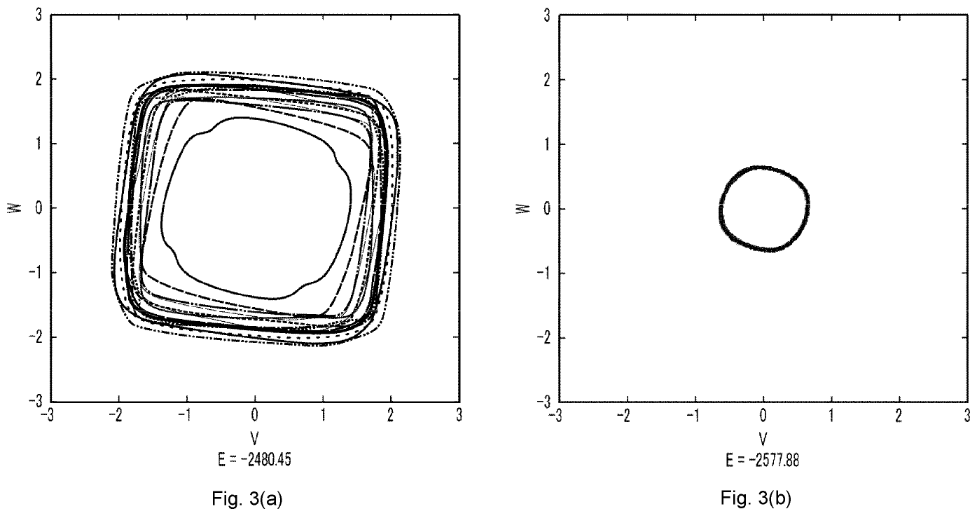

The trajectories of two pulses in the vw-plane (i being omitted), that is, the amplitudes of the two pulses, are illustrated in FIG. 3. The argument at a point on this trajectory is the variable θ of the XY model.

FIG. 3A illustrates trajectories of amplitudes of the two pulses in the vw-plane when amplitude correction is not performed. The horizontal axis of FIG. 3A is the amplitude of v, and the vertical axis is the amplitude of w. The result illustrated in FIG. 3A indicates that the amplitudes are non-uniform and the trajectories do not form a circle.

FIG. 3B illustrates trajectories of the amplitudes of the two pulses in the vw-plane when amplitude correction is performed. When amplitude correction is performed, the obtained result indicates that the amplitudes are uniform and the trajectories form a circle close to a perfect circle. When the amplitudes are uniform and close to a perfect circle, an answer having high accuracy is obtained. At this time, the argument may be obtained to be a real number at the measurement accuracy.

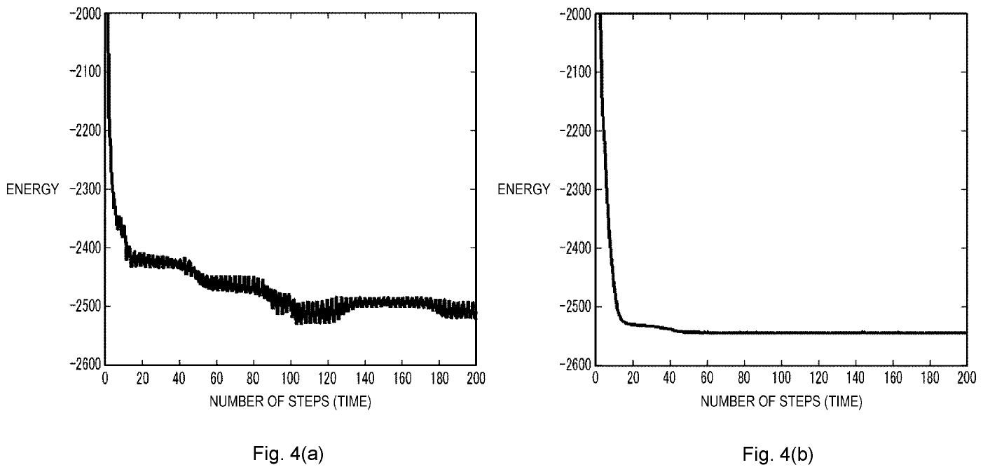

An XY model in which the number of spins N is 100 is employed to describe the energy of a complex XY model with reference to FIG. 4. FIG. 4A illustrates a relationship between the number of steps (time) and the energy when amplitude correction is not performed in the complex XY model. When the amplitude correction is not performed, the energy temporarily decreases as the number of steps (time) increases. However, the energy value often oscillates irregularly. A lower limit value of energy E is −2480.45.

FIG. 4B illustrates a relationship between the number of steps (time) and the energy when amplitude correction is performed in the complex XY model. A lower limit value of the energy E is −2577.88. With increase of the number of steps (time), the energy value oscillates stably.

Note that the XY model calculation apparatus adopted in the first and second embodiments may be employed in a combination optimization problem calculation apparatus that solves the above-described combination optimization problem by using the XY model calculation apparatus.

1. An XY model calculation apparatus, comprising:
a resonator unit configured to amplify a plurality of optical pulses;
a measurement unit configured to measure phases and amplitudes of the plurality of optical pulses to obtain a measurement result; and
a feedback configuration configured to calculate and feed back an interaction related to a certain optical pulse of the plurality of optical pulses by using a coupling coefficient of an Ising model in response to the measurement result and, wherein
the feedback configuration is configured to perform a feedback input of a correlation to be determined by a coupling coefficient of two optical pulses of the plurality of optical pulses, and
configured so that only one component of pulsed light is to be measured.

2. The XY model calculation apparatus according to claim 1, wherein
the component of the pulsed light is an in-phase component.

3. The XY model calculation apparatus according to claim 1, wherein
by satisfying, in a Hamiltonian equation (1) of an XY model,
$$\begin{matrix}Math . 1 & \\ {H}_{x y} = {\sum }_{ij} {K}_{i j} cos ( {θ}_{i} - {θ}_{j} ) & ( 1 )\end{matrix}$$
a coupling matrix
Jᵢⱼ Math. 5
of Equation (6),
$$\begin{matrix}Math . 6 & \\ {J}_{ij} = ( \begin{matrix}0 & {K}_{21} & {K}_{31} & & {J}_{wv} & 0 & 0 \\ {K}_{12} & 0 & {K}_{32} & … & 0 & {J}_{wv} & 0 \\ {K}_{13} & {K}_{23} & 0 & & 0 & 0 & {J}_{wv} \\ & ⋮ & & ⋱ & & ⋮ & \\ {J}_{vw} & 0 & 0 & & 0 & {K}_{21} & {K}_{31} \\ 0 & {J}_{vw} & 0 & … & {K}_{12} & 0 & {K}_{32} \\ 0 & 0 & {J}_{vw} & & {K}_{13} & {K}_{23} & 0\end{matrix} ) & ( 6 )\end{matrix}$$
where
θᵢ Math. 2
is a phase of an i-th spin, where i is a natural number,
θⱼ Math. 3
is a phase of a j-th spin, where j is a natural number, and
Kᵢⱼ Math. 4
is a real symmetric matrix, and
θᵢ Math. 7
is a phase of an i-th spin, where i is a natural number i,
θⱼ Math. 8
is a phase of a j-th spin, where j is a natural number, and
Kᵢⱼ Math. 9
is a Hermitian matrix, and
by satisfying, in a Hamiltonian equation (2) of a complex (numerical system) XY model,
Math. 10
H_{cxy}=ΣᵢⱼKᵢⱼ exp[i(θᵢ−θⱼ)] (2)
a coupling matrix of Equation (11),
$$\begin{matrix}Math . 14 & \\ {J}_{ij} = ( \begin{matrix}0 & {K}_{21} & {K}_{31} & & {J}_{wv} & - {K}_{21} & - {K}_{31} \\ {K}_{12} & 0 & {K}_{32} & … & - {K}_{12} & {J}_{wv} & - {K}_{32} \\ {K}_{13} & {K}_{23} & 0 & & - {K}_{13} & - {K}_{23} & {J}_{wv} \\ & ⋮ & & ⋱ & & ⋮ & \\ {J}_{wv} & {K}_{21} & {K}_{31} & & 0 & {K}_{21} & {K}_{31} \\ {K}_{12} & {J}_{wv} & {K}_{32} & … & {K}_{12} & 0 & {K}_{32} \\ {K}_{13} & {K}_{23} & {J}_{wv} & & {K}_{13} & {K}_{23} & 0\end{matrix} ) \\ {K}_{ij} : Real part of Kij \\ {K}_{ij} : Imaginary part of Kij & ( 11 )\end{matrix}$$
where
θᵢ Math. 11
is a phase of an i-th spin, where i is a natural number i,
θⱼ Math. 12
is a phase of an j-th spin, where j is a natural number, and
Kᵢⱼ Math. 13
is a Hermitian matrix,
a real number θ is given as an argument in a plane having amplitudes of the two optical pulses as axes, and the argument changes continuously to rotate from 0 to 2π.

4. The XY model calculation apparatus according to claim 1, wherein
a feedback signal
αᵢ Math. 21
to be used for the feedback input is determined so that a relationship
$$\begin{matrix}Math . 18 & \\ {\tilde{α}}_{i} = ( {\sum }_{ij} ( {K}_{ij} {v}_{j} + {K}_{ij} {w}_{j} ) ) \\ {α}_{i} = {J}_{vw} {w}_{j} + {\tilde{α}}_{i} & ( 9 )\end{matrix}$$
$$\begin{matrix}Math . 19 & \\ {\tilde{β}}_{i} = ( {\sum }_{ij} ( {K}_{ij} {w}_{j} + {K}_{ij} {v}_{j} ) ) \\ {β}_{i} = {J}_{wv} {v}_{i} + {\tilde{β}}_{i} & ( 10 )\end{matrix}$$
$$\begin{matrix}Math . 20 & \\ {α}_{i} = {J}_{vw} {w}_{i} + {\tilde{α}}_{i} - {E}_{i} {v}_{i} \\ {β}_{i} = {J}_{wv} {v}_{i} + {\tilde{β}}_{i} - {E}_{i} {w}_{i} \\ {E}_{i} = ( \frac{{\tilde{α}}_{i} {v}_{i} + {\tilde{β}}_{i} {w}_{i}}{{v}_{i}^{2} + {w}_{i}^{2}} ) & ( 12 )\end{matrix}$$
is satisfied by
αᵢ Math. 17
where i and j are natural numbers, vⱼ is an amplitude of an optical pulse v at a j-th site of one of the two optical pulses, wⱼ is an amplitude of an optical pulse w at a j-th site of the other of the two optical pulses, a matrix Kij of complex numbers is a coupling coefficient, [symbol]
Kᵢⱼ Math. 15
is a real part of Kij, and
ℑKᵢⱼ Math. 16
is an imaginary part of Kij.

5. A combination optimization problem calculation apparatus using the XY model calculation apparatus according to claim 1.

6. A combination optimization problem calculation apparatus using the XY model calculation apparatus according to claim 2.

7. A combination optimization problem calculation apparatus using the XY model calculation apparatus according to claim 3.

8. A combination optimization problem calculation apparatus using the XY model calculation apparatus according to claim 4.
